(19) United States
(12) Patent Application Publication
(10) Pub. No.: US 2006/0154002 A1
(43) Pub. Date: Jul. 13, 2006

(54) Recording paper

(75) Inventors: Masaya Shibatani, Nagano (JP); Masako Horai, Nagano (JP); Nobuyuki Nagai, Nagano (JP)

Correspondence Address: LADAS & PARRY, 26 WEST 61ST STREET, NEW YORK, NY, 10023, US

(73) Assignee: SEIKO EPSON CORPORATION

(21) Appl. No.: 11/311,699

(22) Filed: Dec. 19, 2005

(30) Foreign Application Priority Data
Dec. 22, 2004 (JP) 2004-370573

(51) Int. Cl. B41M 5/00

(52) U.S. Cl. 428/32.24

(57) ABSTRACT

The present invention provides a recording paper comprising: a resin-coated paper comprising a base paper at least one surface of which is coated with a resin; and an ink-receiving layer provided on the resin-coated paper, and being printable by an ink-jet printer, wherein the recording paper has a thickness of 280 μm or more and a stiffness defined by JIS-P8125 of 2.8 to 4.0 mN·m, and gives a decreasing rate in friction coefficient of a paper-contacting surface of a paper-feeding roller of an ink-jet printer between before and after friction of the paper-contacting surface with the ink-receiving layer plural times of 5% or less.

### FIELD OF THE INVENTION

The present invention relates to a recording paper which is suitable as a recording paper for an ink-jet process, provides a high-grade impression, and hardly induces paper-feeding failure.

### BACKGROUND OF THE INVENTION

An ink-jet process is a printing process wherein an image is recorded by discharging ink drops from a nozzle provided on a recording head and attaching the ink onto a recording paper such as paper. Since a high ink-absorbing ability is required for the recording paper for ink-jet recording, a paper having an ink-receiving layer provided on a support by coating has been developed in order to cope therewith, and widely used as an ink-jet recording paper or the like. As a support for the ink-jet recording paper, paper is hitherto generally used, but in the case of obtaining a photo-like image quality having a silver-salt photographic tone, use of paper as the support affords insufficient results in gloss, texture, water resistance, and the like. Thus, recently, an ink-jet recording paper using a resin-coated paper obtained by coating both surfaces of paper with a resin such as polyethylene as a support (see, for example, Patent Document 1) has been developed and widely used.

Patent Document: JP-A-2001-63205

With regard to an ink-jet recording paper using the above resin-coated paper as a support, a high-grade impression is frequently required for products after printing. A high-grade impression is largely attributed to image quality, but massive feeling and resiliency of printed matter when picked up are also important factors for producing a high-grade impression. Accordingly, among ink-jet recording papers using a resin-coated paper as a support, there are those where a high-grade impression is further emphasized by increasing thickness as compared with conventional ones to enhance massive feeling and resiliency, and they are put into use. However, such a thick recording paper tends to induce paper-feeding failure. In particular, there is a problem that a recording paper is not fed into a printer when plural sheets of the recording paper are continuously fed into the printer, i.e., a problem of so-called “non-feeding”.

### SUMMARY OF THE INVENTION

Therefore, an object of the invention is to provide a recording paper which is suitable as a recording paper for an ink-jet process, provides a high-grade impression, and hardly induces paper-feeding failure.

Other objects and effects of the invention will become apparent from the following description

The invention provides a recording paper comprising: a resin-coated paper comprising a base paper at least one surface of which is coated with a resin; and an ink-receiving layer provided on the resin-coated paper, and being printable by an ink-jet printer,

wherein the recording paper has a thickness of 280 μm or more and a stiffness defined by JIS-P8125 of 2.8 to 4.0 mN·m, and gives a decreasing rate in friction coefficient of a paper-contacting surface of a paper-feeding roller of an ink-jet printer between before and after friction of the paper-contacting surface with the ink-receiving layer plural times of 5% or less,

whereby the above objects have been achieved.

Since the recording paper of the invention has a thickness and a stiffness, and gives a decreasing rate in friction coefficient, each within a specific range, respectively, the paper possesses a high-grade impression and an excellent paper-feeding property, so that non-feeding, i.e., a problem that a recording paper is not fed into a printer, hardly occurs even when plural sheets of the paper are continuously fed into a printer. The paper is also excellent in handling and can be suitably used in a high-grade photographic application such as output of photo-like images having a silver-salt photographic tone.

### BRIEF DESCRIPTION OF THE DRAWINGS

FIG. 1 is a cross-sectional view illustrating a paper-feeding mechanism in a common ink-jet printer in a typical manner.

FIG. 2 shows a measurement method of the decreasing rate in friction coefficient.

The reference numerals used in the drawing denote the followings, respectively.
1: Hopper
2: Paper-feeding roller
3: Retard roller
4: Carriage
5: Recording head

### DETAILED DESCRIPTION OF THE INVENTION

The present invention will be described in detail below.

The recording paper of the invention comprises a resin-coated paper obtained by coating at least one surface of a base paper with a resin and an ink-receiving layer provided on at least one surface of the resin-coated paper by coating, which thickness, stiffness defined by JIS-P8125, and decreasing rate in friction coefficient as described below each fall within respective specific ranges. By regulating these three physical properties so as to fall within respective specific ranges, realization of both of a high-grade impression and an excellent paper-feeding property becomes possible.

The thickness of the recording paper of the invention is 280 μm or more, preferably 285 to 320 μm. The control of the thickness is preferably carried out by controlling the thickness of each layer (the resin-coated paper or the ink-receiving layer), in particular, mainly by changing the thickness of the resin-coated paper. It is preferable that the thickness of the ink-receiving layer is only changed within a predetermined range which is determined from the viewpoints of ink-absorbing ability, inhibition of powder-dropping, and the like and is not so largely increased or decreased. The change in the thickness of the ink-receiving layer may have a large influence on the other properties. When the thickness of the ink-receiving layer is decreased, there is a risk of decrease in ink-absorbing ability. Contrarily, when the thickness of the ink-receiving layer is increased, there is a possibility of invitation of cracking of the ink-receiving layer or elevation of production cost.

The following will describe items regarding to the thickness of the above recording paper. The thickness of the base paper constituting the above resin-coated paper is preferably 180 to 240 μm from the viewpoints of achieving the above thickness of the recording paper and making the stiffness of the recording paper within the specific range mentioned below.

Moreover, the thickness of the resin for coating one surface or both surfaces of the above base paper is preferably 20 to 35 μm. When the thickness of the resin is less than 20 μm, smoothness of the surface of the resin layer decreases under the influence of unevenness of the surface of the base paper and hence there is a possibility that a recording paper having a high surface gloss is not obtained. When the thickness of the resin exceeds 35 μm, the texture of the recording paper becomes a plastic tone and hence the case is not preferable in a high-grade photographic application.

The thickness of the above ink-receiving layer is preferably 25 to 45 μm from the viewpoints of achieving the above thickness of the recording paper and making the stiffness of the recording paper and the decreasing rate in friction coefficient within respective specific ranges mentioned below in consideration of securing a sufficient ink-absorbing ability, inhibiting power dropping, preventing occurrence of cracking, reducing cost, and the like.

Moreover, as the resin-coated paper, one obtained by coating one surface of a base paper with a resin may be used but one obtained by coating both surfaces of a base paper with a resin is preferable in view of curling prevention.

Furthermore, in the recording paper having a constitution wherein the above ink-receiving layer is provided on one surface of the resin-coated paper comprising a base paper both surfaces of which is coated with a resin, it is preferable that the thickness of the resin at the side on which the ink-receiving layer is not provided is equal to or larger than the thickness of the resin at the side on which the ink-receiving layer is provided. As mentioned above, by making the thickness of the resin at the side on which the ink-receiving layer is not provided (back side) equal to or larger than the thickness of the resin at the surface side, curling can be effectively prevented and a transferring property of the recording paper inside a printer is improved.

The stiffness of the recording paper of the invention defined by JIS-P8125 (a measured value in the longitudinal direction of the paper) is 2.8 to 4.0 mN·m. The control of the stiffness of the recording paper is preferably carried out mainly by changing the thickness of the above resin-coated paper similarly to the case of the control of the thickness of the recording paper mentioned above.

As one example of recording paper having a value of the above stiffness ranging from 2.8 to 4.0 mN·m, there may be, for example, mentioned a recording paper having a constitution wherein the above ink-receiving layer is provided on one surface of the resin-coated paper comprising a base paper both surfaces of which is coated with a resin, the thickness of the resin being 20 to 35 μm and the stiffness of the base paper defined by JIS-P8125 is 0.7 to 2.1.

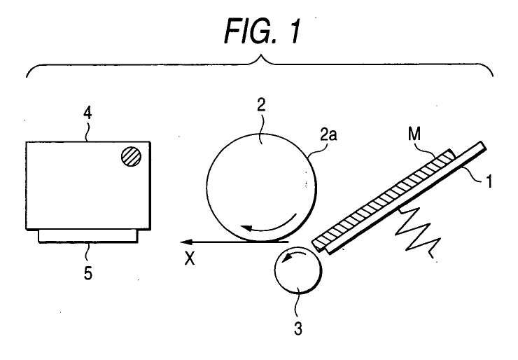

In the recording paper of the invention, the decreasing rate in friction coefficient of a paper-contacting surface of a paper-feeding roller of an ink-jet printer between before and after friction of the paper-contacting surface with the surface of the above ink-receiving layer (i.e., the surface to be recorded) plural times is 5% or less. As shown in FIG. 1, the ink-jet printer is generally constituted so that a recording paper M placed on a hopper 1 with placing the side on which the ink-receiving layer is provided upward is fed in the paper-feeding direction X with picking up the paper between a paper-feeding roller 2 and a retard roller 3, and an ink is applied onto the surface of the ink-receiving layer from a recording head 5 mounted on a carriage 4. When plural sheets of a recording paper are fed by the printer having such a constitution, smudges are attached to a paper-contacting surface (roller circumferential surface) 2a of the paper-feeding roller 2 proportional to the number of paper-feeding times owing to paper powder derived from the recording paper and the like. This results in a decrease in friction coefficient of the paper-contacting surface 2a, whereby a problem that the recording paper is not fed into the printer, so-called non-feeding, tends to occur. Particularly, in the case that the recording paper has a large thickness or a high stiffness, the non-feeing tends to occur. To the contrary, since the recording paper of the invention is constituted so that the decreasing rate in friction coefficient of the paper-contacting surface on the paper-feeding roller is 5% or less, paper-feeding failure hardly occurs even when plural sheets are fed into the ink-jet printer having such a constitution shown in FIG. 1.

The above-mentioned decreasing rate in friction coefficient can be determined in accordance with the following procedures [1] to [5].

Procedure [1]:

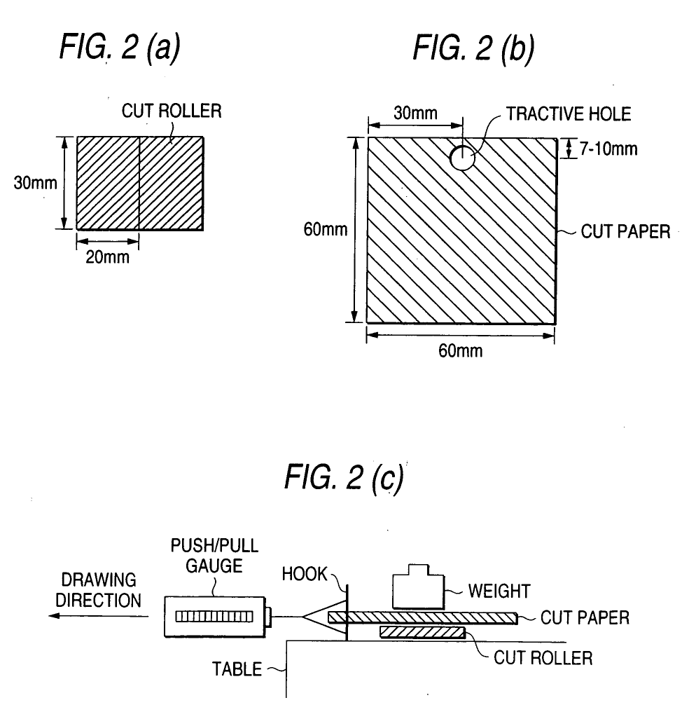

As a preparation stage, two sheets of cut rollers which are cut out from a paper-feeding roller (made of ethylene propylene rubber, thickness of 4±2 mm) into a rectangular form of 30 mm×20 mm are prepared, and they are placed side by side and attached onto a flat table with a two-sided tape with directing the paper-contacting surface (roller circumferential surface) upward (see, FIG. 2a). The paper-contacting surface is thoroughly wiped with alcohol. In addition, a recording paper cut into a rectangular form of 60 mm×60 mm (cut paper) is prepared and a tractive hole for hooking a hook of a push/pull gauge mentioned below is made by means of a punch or the like at a position 7 to 10 mm apart from the middle point in any one side edge of the rectangular form (see, FIG. 2b).

Procedure [2]:

The above cut paper is overlaid on the cut roller. At that time, it is overlaid so that the above paper-contacting surface contacts with the front surface (i.e., surface to be recorded) of the ink-receiving layer of the cut paper. Furthermore, two weights each having a weight of 100 g (diameter of 25 mm±1 mm) are placed side by side on nearly the center of the part where the cut roller and the cut paper overlap each other.

Procedure [3]:

The hook of the push/pull gauge (a digital tension meter having an allowable load of about 2 kg) is hooked to the above tractive hole of the above cut paper. With setting the gauge to a maximum measurement, the cut paper is drawn at a drawing rate of 6 mm/s with maintaining the gauge horizontally. At that time, a measured value is recorded (see, FIG. 2c).

Procedure [4]:

The above procedures [2] and [3] are repeated under room temperature 500 times in total and the measured values at first time and 500th time are recorded. The above cut paper is exchanged each time but the wiping of the above paper-contacting surface of the above cut roller with alcohol is performed only in the above Procedure [1] and not each time.

Procedure [5]:

A value obtained by dividing the measured value at first time obtained in the above Procedure [4] by 200 is designated as an “initial value” and a value obtained by dividing the measured value at 500th time by 200 as an “final value”. The decreasing rate in friction coefficient is calculated according to the following equation.
Decreasing rate in friction coefficient (%)={(Initial value−Final value)/Initial value}×100

The above decreasing rate in friction coefficient varies depending on the constitution of the above ink-receiving layer and can be controlled by changing the composition of the ink-receiving layer. An ink-receiving layer which can achieve a decreasing rate in friction coefficient of 5% or less will be described later.

The following will describe individual constituting members (the resin-coated paper and the ink-receiving layer) of the recording paper of the invention.

The base paper constituting the above resin-coated paper is not particularly limited and a commonly used paper can be employed. Examples of a pulp constituting the paper include, for example, a virgin pulp, a recycled pulp, a synthetic pulp and the like, and one of these or a mixture of two or more thereof can be used. Into the paper can be incorporated, if necessary, various additives such as a sizing agent, a paper-strength enhancer, a filler, an antistatic agent, a fluorescent whitening agent and a dye, which are generally used in paper manufacture. Moreover, the paper may be coated with a surface sizing agent, a surface paper-strength enhancer, a fluorescent whitening agent, an antistatic agent, a dye, an anchoring agent, and the like. Furthermore, the paper may be subjected to a surface smoothing treatment in a usual manner using a calendering apparatus during or after paper-making.

The basis weight of the above base paper is preferably 140 to 192 g/m².

Moreover, from the viewpoint of enhancing surface glossiness of the above ink-receiving layer and obtaining a recording paper having a high-grade impression, the Bekk smoothness of the above base paper, defined by JIS-P8119, is preferably 300 seconds or more.

As the resin constituting the above resin-coated paper, a polyolefin resin or an electron beam-curable resin capable of curing with an electron beam can be used. The polyolefin resin include, for example, olefin homopolymers such as low-density polyethylene, high-density polyethylene, polypropylene, polybutene, and polypentene, copolyers of two or more olefins, such as ethylene-propylene copolymers, and mixtures thereof. Those having different density and melt index can be used solely or as a mixture. Among them, low-density or high-density polyethylene is particularly preferred in view of texture, strength, water resistance, and cost.

Into the above resin can be incorporated various additives, e.g., a white pigment such as titanium oxide, zinc oxide, talc, or calcium carbonate, a fatty acid amide such as stearic acid amide or arachidic acid amide, a fatty acid metal salt such as zinc stearate, calcium stearate, aluminum stearate, or magnesium stearate, an antioxidant such as Irganox 1010 or 1076, a coloring pigment or coloring dye, a fluorescent whitening agent, and a UV absorber, if necessary.

In the case that a polyolefin resin is used as the above resin, the above resin-coated paper can be produced by a so-called extrusion coating process wherein a polyolefin resin melted under heating is subjected to flow casting on the running above paper. In the case that an electron beam-curable resin is used as the above resin, the above paper can be produced by applying the electron beam-curable resin on the paper by means of a known coater such as a gravure coater or a blade coater and then irradiating the paper with an electron beam to cure the resin. Before coating the paper with the resin, the paper may be subjected to activation treatment such as corona discharge treatment or flame treatment.

As the above ink-receiving layer, a coated layer having a sufficient absorbing ability with respect to inks for ink-jet recording (usually aqueous inks) may be usable. For example, there may be mentioned a porous ink-receiving layer (also called as an absorption type, a porous type, or a void type) obtainable by binding a pigment with a binder, or a so-called swelling type ink-receiving layer wherein a water-soluble polymer such as gelatin is used as a main component. Preferred is a porous ink-receiving layer.

The following will describe a composition capable of achieving the above decreasing rate in friction coefficient of 5% or less, in regard to the porous ink-receiving layer.

The pigment constituting the above porous ink-receiving layer include, for example, white inorganic pigments such as precipitated calcium carbonate, ground calcium carbonate, magnesium carbonate, kaolin, talc, calcium sulfate, barium sulfate, titanium oxide, zinc sulfide, zinc carbonate, satin white, aluminum silicate, diatomaceous earth, calcium silicate, magnesium silicate, synthetic amorphous silica, colloidal silica, alumina, alumina hydrate, aluminum hydroxide, lithopone, zeolite, hydrated halocite, and magnesium hydroxide, and organic pigments such as styrene-based plastic pigments, acrylic plastic pigments, polyethylene, microcapsules, urea resins, and melamine resins. There may be used one of these singly or two or more thereof as a mixture.

As the above pigment, particularly preferred is fumed silica. The fumed silica is silica fine particles produced by a gas-phase process. The composition of the silica fine particles is 93% or more of SiO₂, about 5% or less of Al₂O₃, and about 5% or less of Na₂O on the basis of dry weight. The gas-phase process is a process for producing fine particles by thermal decomposition of vapor of a volatile metal compound or cooling and condensation of vapor-phase species formed by heating and vaporization of a starting material. In addition to the gas-phase process, there are several processes for producing silica fine particles such as a liquid-phase process, a pulverizing solid-phase process, and a crystallization solid-phase process.

The above fumed silica preferably has an average primary particle diameter of 3 to 50 nm, more preferably has an average primary particle diameter of 5 to 30 nm.

The content of the above pigment is preferably 40 to 90% by weight based on the weight of the total solid matter of the above ink-receiving layer. When the content is less than 40% by weight, there is a possibility that an ink-absorbing ability is insufficient. Contrarily, when the content exceeds 90%, there is a risk that the strength of the coated film of the ink-receiving layer is deficient and hence inconveniences such as powder-dropping may occur.

As the binder (a binder of the pigment) constituting the above porous ink-receiving layer, a water-soluble or water-insoluble polymer compound having affinity to inks can be incorporated. Specifically, examples thereof include, for example, cellulose-based adhesives such as methylcellulose, methyl hydroxyethylcellulose, methyl hydroxypropylcellulose, and hydroxyethylcellulose, natural polymer resins such as starch and modified products thereof, gelatin and modified products thereof, casein, pullulan, gum arabic, and albumin, or derivatives thereof, latexes and emulsions such as polyvinyl alcohol and modified products thereof, styrene-butadiene copolymers, styrene-acryl copolymers, methyl methacrylate-butadiene copolymers, and ethylene-vinyl acetate copolymers, vinyl polymers such as polyacrylamide and polyvinylpyrrolidone, polyethyleneimine, polypropylene glycol, polyethylene glycol, and maleic anhydride or copolymers thereof, vinylpyrrolidone/vinyl acetate copolymers, and acetal resins such as polyvinyl butyral and polyvinyl formal. There may be used one of these singly or two or more thereof as a mixture.

Preferred as the above binder are polyvinyl alcohol and a modified product thereof (a modified polyvinyl alcohol) and, particularly, a polyvinyl alcohol having a saponification degree of 75 to 98 mol % and an average degree of polymerization of 500 to 3,000 and a modified product thereof are preferred. The modified product include cation-modified products and silanol-modified products. Such polyvinyl alcohol and the like can enhance the layer strength by adding a relatively small amount thereof without inhibiting aqueous ink-absorbing ability of the ink-receiving layer and also facilitate the achievement of the decreasing rate in friction coefficient of 5% or less.

The content of the above binder is preferably 2 to 50% by weight based on the above pigment in the above ink-receiving layer. When the content of the binder is less than 2% relative to the pigment, there is a possibility that the film strength is deficient. Contrarily, when the content exceeds 50% by weight, there is a risk of decreased ink absorbing ability.

Into the above ink-receiving layer can be suitably incorporated, in addition to the above pigment and binder, a crosslinking agent, a pigment dispersant, a thickening agent, a flow improver, a deforming agent, a form inhibitor, a releasing agent, a foaming agent, a penetrant, a coloring dye, a coloring pigment, a fluorescent whitening agent, a UV absorber, an antioxidant, an antiseptic, an antifungal agent, and the like, if necessary.

Moreover, for the purpose of further enhancing color developing property and water resistance of a recorded image, a cationic substance (an ink fixing agent) can be incorporated into the above ink-receiving layer. The cationic substance include, for example, low-molecular-weight compounds such as primary to tertiary amine compounds, primary to tertiary amine salts and quaternary ammonium salts, oligomers having a primary to tertiary amino group, a primary to tertiary amine salt group or a quaternary ammonium salt group, and polymers having these groups. Specifically, examples thereof include cationic organic substances such as diallyldimethylammonium chloride polymer, epihalohydrin-secondary amine copolymers, diallyldimethylammonium chloride-sulfur dioxide copolymers, diallyldimethylammonium chloride-acrylamide copolymers, diallylmethylammonium salt polymers, diallylamine hydrochloride-sulfur dioxide copolymers, dimethylmethylamine hydrochloride copolymers, polyallylamine, polyethyleneimine, polyethyleneimine quaternary ammonium salt compounds, (meth)acrylamidealkylammonium salt polymers, ionenes having a quaternary ammonium salt group, and the like. In addition, multivalent metal ions such as Al³⁺, Ca²⁺, and Mg²⁺, cationic surfactants such as benzalkonium chloride, and the like can be used as the above cationic substances. Preferred is a polymer having a quaternary ammonium salt group.

The content of the above cationic substance (an ink fixing agent) is preferably 0.5 to 15% by weight based on the weight of the total solid matter of the above ink-receiving layer. When the content of the cationic substance is less than 0.5% by weight, improving effects of color developing property and water resistance of a recorded image are poor. Contrarily, when the content exceeds 15% by weight, there is a possibility that a decrease in ink-absorbing property and a so-called bronze phenomenon occur to decrease in the image quality.

The above ink-receiving layer can be formed by applying a coating solution containing the above various components by a known coating method.

The surface of the ink-receiving layer preferably has a high glossiness. Specifically, 20° glossiness thereof defined by JIS-Z8741 is preferably 40% or more, particularly 50% or more. The control of the glossiness of the surface of the ink-receiving layer can be carried out by controlling the smoothness of the base paper constituting the above resin-coated paper or increasing the amount of the coated resin.

The recording paper of the invention includes not only one having a constitution wherein the above ink-receiving layer is provided on one surface or both surfaces of the above resin-coated paper by coating, but also include ones wherein layers having various functions, such as a curl-preventing layer and a slip-preventing layer are further provided by coating. For example, it is possible to provide an intermediate layer (an underlying layer) for enhancing the adhesion between the resin-coated paper and the ink-receiving layer. Moreover, the above ink-receiving layer may be a monolayer structure having a single composition or may have a constitution wherein multiple layers having a different composition are laminated.

### EXAMPLES

The present invention will be illustrated in more detail with reference to the following Examples, but the invention should not be construed as being limited thereto.

### Example 1

One surface (the titanium oxide-containing resin side) of Resin-coated Paper A produced by the following procedure was coated with Coating Solution A having the composition shown below by means of a bar coater so that the thickness after drying was 38 μm and then dried to form an ink-receiving layer. The recording paper thus obtained was used as a sample of Example 1. The 20° glossiness of the surface of the ink-receiving layer defined by JIS-Z8741 of the recording paper was found to be 59%.

<Resin-Coated Paper A>

One surface (side on which an ink-receiving layer was to be provided) of a base paper composed of a pulp blend of LBKP (50 parts) and LBSP (50 parts) and having a thickness of 192 μm and a stiffness defined by JIS-P8125 of 1.26 was coated with a resin composition composed of low-density polyethylene (70 parts), high-density polyethylene (20 parts), and titanium oxide (10 parts) so that the thickness after drying was 30 μm and the other surface (side on which an ink-receiving layer was not to be provided) of the base paper was coated with a resin composition composed of high-density polyethylene (50 parts) and low-density polyethylene (50 parts) so that the thickness after drying was 34 μm, whereby Resin-coated Paper A was produced.

<Composition of Coating Solution A>

Vapor-phase-process silica (manufactured by Japan Aerosil, A300, average primary particle diameter of 10 to 30 nm): 60 parts by weight

Binder (manufactured by Kuraray Co., Ltd., PVA217, saponification degree of 88 mol %, average polymerization degree of 1,700): 20 parts by weight

Ink-fixing agent (manufactured by Nitto Boseki Co., Ltd., PAS-A-1): 4 parts by weight

Titanium lactate (crosslinking agent, manufactured by Matsumoto Seiyaku Kogyo, TC-400): 0.2 part by weight

Water: 200 parts by weight

### Example 2

A recording paper was produced in the same manner as in Example 1 except that the Resin-coated Paper B shown below was used instead of the above Resin-coated Paper A and Coating Solution B having the composition shown below was used instead of the above Coating Solution A. The recording paper thus obtained was used as a sample of Example 2. The 20° glossiness of the surface of the ink-receiving layer defined by JIS-Z8741 in the recording paper was found to be 58%.

<Resin-Coated Paper B>

One surface (side on which an ink-receiving layer was to be provided) of a base paper composed of a pulp blend of LBKP (50 parts) and LBSP (50 parts) and having a thickness of 205 μm and a stiffness defined by JIS-P8125 of 1.33 was coated with a resin composition composed of low-density polyethylene (70 parts), high-density polyethylene (20 parts), and titanium oxide (10 parts) so that the thickness after drying was 29 μm and the other surface (side on which an ink-receiving layer was not to be provided) of the base paper was coated with a resin composition composed of high-density polyethylene (50 parts) and low-density polyethylene (50 parts) so that the thickness after drying was 35 μm, whereby Resin coated paper B was produced.

<Composition of Coating Solution B>

Vapor-phase-process silica (manufactured by Japan Aerosil, A300, average primary particle diameter of 10 to 30 nm): 55 parts by weight

Binder (manufactured by Kuraray Co., Ltd., PVA224, saponification degree of 88 mol %, average polymerization degree of 2,400): 22 parts by weight

Ink-fixing agent (manufactured by Nitto Boseki Co., Ltd., PAS-A-1): 4 parts by weight

Sodium borate (crosslinking agent): 0.3 part by weight

Water: 210 parts by weight

### Comparative Example 1

A recording paper was produced in the same manner as in Example 1 except that the Resin-coated Paper C shown below was used instead of the above Resin-coated Paper A. The recording paper thus obtained was used as a sample of Comparative Example 1. The 20° glossiness of the surface of the ink-receiving layer defined by JIS-Z8741 in the recording paper was found to be 51%.

<Resin-Coated Paper C>

One surface (side on which an ink-receiving layer was to be provided) of a base paper composed of a pulp blend of LBKP (50 parts) and LBSP (50 parts) and having a thickness of 202 μm and a stiffness defined by JIS-P8125 of 1.26 was coated with a resin composition composed of low-density polyethylene (70 parts), high-density polyethylene (20 parts), and titanium oxide (10 parts) so that the thickness after drying was 18 μm and the other surface (side on which an ink-receiving layer was not to be provided) of the base paper was coated with a resin composition composed of high-density polyethylene (50 parts) and low-density polyethylene (50 parts) so that the thickness after drying was 19 μm, whereby Resin coated paper C was produced.

### Comparative Example 2

A recording paper was produced in the same manner as in Example 1 except that the Resin-coated Paper D shown below was used instead of the above Resin-coated Paper A. The recording paper thus obtained was used as a sample of Comparative Example 2. The 20° glossiness of the surface of the ink-receiving layer defined by JIS-Z8741 in the recording paper was found to be 52%.

<Resin-Coated Paper D>

One surface (side on which an ink-receiving layer was to be provided) of a base paper composed of a pulp blend of LBKP (50 parts) and LBSP (50 parts) and having a thickness of 175 μm and a stiffness defined by JIS-P8125 of 0.65 was coated with a resin composition composed of low-density polyethylene (70 parts), high-density polyethylene (20 parts), and titanium oxide (10 parts) so that the thickness after drying was 18 μm and the other surface (side on which an ink-receiving layer was not to be provided) of the base paper was coated with a resin composition composed of high-density polyethylene (50 parts) and low-density polyethylene (50 parts) so that the thickness after drying was 19 μm, whereby Resin coated paper D was produced.

### Comparative Example 3

A recording paper was produced in the same manner as in Example 1 except that the Resin-coated Paper E shown below was used instead of the above Resin-coated Paper A. The recording paper thus obtained was used as a sample of Comparative Example 3. The 20° glossiness of the surface of the ink-receiving layer defined by JIS-Z8741 in the recording paper was found to be 62%.

<Resin-Coated Paper E>

One surface (side on which an ink-receiving layer was to be provided) of a base paper composed of a pulp blend of LBKP (50 parts) and LBSP (50 parts) and having a thickness of 242 μm and a stiffness defined by JIS-P8125 of 2.15 was coated with a resin composition composed of low-density polyethylene (70 parts), high-density polyethylene (20 parts), and titanium oxide (10 parts) so that the thickness after drying was 36 μm and the other surface (side on which an ink-receiving layer was not to be provided) of the base paper was coated with a resin composition composed of high-density polyethylene (50 parts) and low-density polyethylene (50 parts) so that the thickness after drying was 37 μm, whereby Resin coated paper E was produced.

### Comparative Example 4

A recording paper was produced in the same manner as in Example 1 except that Coating Solution C having the composition shown below was used instead of the above Coating Solution A. The recording paper thus obtained was used as a sample of Comparative Example 4. The 20° glossiness of the surface of the ink-receiving layer defined by JIS-Z8741 in the recording paper was found to be 55%.

<Composition of Coating Solution C>

Vapor-phase-process silica (manufactured by Japan Aerosil, A300, average primary particle diameter of 10 to 30 nm): 73 parts by weight

Binder (manufactured by Kuraray Co., Ltd., PVA217, saponification degree of 88 mol %, average polymerization degree of 1,700): 18 parts by weight

Ink-fixing agent (manufactured by Nitto Boseki Co., Ltd., PAS-A-1): 4 parts by weight

Water: 200 parts by weight

### Test Example

With regard to the above each sample (recording paper), thickness, stiffness defined by JIS-P8125, decreasing rate in friction coefficient, high-grade impression, and paper-feeding property were evaluated. The evaluation of the decreasing rate in friction coefficient was carried out using a paper-feeding rubber roller (brand-new) attached to an Ink-jet printer PM-G700 manufactured by Seiko Epson Corp. in accordance with the above-mentioned procedures [1] to [5]. The evaluation of the high-grade impression and the paper-feeding property was carried out in accordance with the following methods, respectively. The evaluation results thereof are shown in Table 1 below.

(Evaluation of High-Grad Impression)

The above sample was compared with a commercially available printing paper for silver-salt photograph (manufactured by Fuji Photo Film Co., Ltd., heavy duty, thickness of 230 μm, stiffness defined by JIS-P8125 of 2.46) by 30 monitor persons and a ratio of persons who felt a high-grade impression for the sample was determined.

(Evaluation of Paper-Feeding Property)

Plural sheets of each sample having an A4 size were set in a paper cassette of the above printer PM-G700 and they were continuously fed without printing action. The number of sheets passed through until non-feeding (a state where the printer failed to pick up the recording paper set in the paper cassette and a paper-feeding error occurred) occurred was recorded. This operation was conducted three times and the average value of the number of sheets passed through over the three times of the operation was calculated. It can be said that the recording paper showing a larger average value of the number of sheets passed is a recording paper which is excellent in paper-feeding property and hardly induces paper-feeding failure.

TABLE 1

| | | | Decreasing | High- | |
|---|---|---|---|---|---|
| | | | rate in | grade | Paper- |
| | Thickness | | friction | impres- | feeding |
| | of paper | Stiffness | coefficient | sion | property |
| | (μm) | (mN · m) | (%) | (%) | (sheet) |
| Example 1 | 294 | 3.2 | 2.3 | 92 | 4859 |
| Example 2 | 307 | 3.5 | 1.9 | 96 | 4980 |
| Comparative | 277 | 2.9 | 2.4 | 59 | 5115 |
| Example 1 | | | | | |
| Comparative | 250 | 2.6 | 2.2 | 52 | 5221 |
| Example 2 | | | | | |
| Comparative | 353 | 4.1 | 2.3 | 47 | 2946 |
| Example 3 | | | | | |
| Comparative | 294 | 3.2 | 5.3 | 97 | 279 |
| Example 4 | | | | | |

The present inventors have confirmed based on the following investigation results that a certain degree of correlation exists between a high-grade impression of a recording paper and thickness and stiffness (stiffness defined by JIS-P8125) thereof. Namely, it can be said that it largely depends on the thickness and stiffness of a recording paper whether users feel a high-grade impression for the recording paper.

The investigation of the above correlation was carried out as follows.

Four kinds of recording papers having a constitution wherein an ink-receiving layer was provided on a resin-coated paper by coating and only having a different thickness (physical properties such as the above stiffness other than thickness were about the same) were prepared (thickness of 230 μm, 260 μm, 290 μm, and 305 μm). When the four kinds of papers were ranked by 30 monitor persons in the order of strong high-grade impression felt, 21 persons corresponding 70% of the total monitor persons ranked proportional to the thickness. From the results, it is understood that a certain degree of correlation exists between thickness and a high-grade impression of a recording paper.

Moreover, based on the recording paper having a thickness of 305 μm, which was the thickest one, i.e., one evaluated to have the most strong high-grade impression, among the above four kinds of papers, a recording paper having a thickness of 305 μm wherein the above stiffness was decreased by 75% was separately prepared. When four kinds in total of the recording papers, i.e., the recording paper (one having the decreased stiffness value) and the above recording papers having a thickness of 230 μm, 260 μm and 290 μm, respectively (ones having no change in the above stiffness) were ranked by the above 30 monitor persons in the order of high-grade impression, the recording paper having a thickness of 305 μm and the decreased stiffness value was demoted from first rank at the preceding evaluation (before the decrease in the above stiffness) to third rank. From the result, it is understood that a certain degree of correlation exists between the above stiffness and a high-grade impression of a recording paper.

While the present invention has been described in detail and with reference to specific embodiments thereof, it will be apparent to one skilled in the art that various changes and modifications can be made therein without departing from the spirit and scope thereof.

This application is based on Japanese Patent Application No. 2004-370573, the contents thereof being herein incorporated by reference.

What is claimed is:

1. A recording paper comprising: a resin-coated paper comprising a base paper at least one surface of which is coated with a resin; and an ink-receiving layer provided on the resin-coated paper, and being printable by an ink-jet printer,
wherein the recording paper has a thickness of 280 μm or more and a stiffness defined by JIS-P8125 of 2.8 to 4.0 mN·m, and gives a decreasing rate in friction coefficient of a paper-contacting surface of a paper-feeding roller of an ink-jet printer between before and after friction of the paper-contacting surface with the ink-receiving layer plural times of 5% or less.

2. The recording paper according to claim 1, wherein the base paper has a thickness of 180 to 240 μm, the resin coating provided on one or both surfaces of the base paper has a thickness of 20 to 35 μm, and the ink-receiving layer has a thickness of 25 to 45 μm.

3. The recording paper according to claim 2, wherein the base paper has a stiffness defined by JIS-P8125 of 0.7 to 2.1.

4. The recording paper according to claim 1, wherein the ink-receiving layer is a porous ink-receiving layer obtainable by binding a pigment with a binder.

5. The recording paper according to claim 4, wherein the ink-receiving layer contains at least fumed silica having an average primary particle diameter of 3 to 50 nm as the pigment.

6. The recording paper according to claim 4, wherein the ink-receiving layer contains a polyvinyl alcohol having a saponification degree of 75 to 98 mol % and an average degree of polymerization of 500 to 3,000 and/or a modified product thereof as the binder.

7. The recording paper according to claim 1, wherein the surface of the ink-receiving layer has a 20° glossiness defined by JIS-Z8741 of 40% or more.
